(19) United States
(12) Patent Application Publication
(10) Pub. No.: US 2013/0324219 A1
(43) Pub. Date: Dec. 5, 2013

(54) LOCATION AWARE-BASED WAGERING GAMES

(71) Applicant: WMS GAMING, INC., Waukegan, IL (US)

(72) Inventor: Jamie W. Vann, Chicago, IL (US)

(73) Assignee: WMS Gaming, Inc., Waukegan, IL (US)

(21) Appl. No.: 13/777,474

(22) Filed: Feb. 26, 2013

Related U.S. Application Data
(60) Provisional application No. 61/700,028, filed on Sep. 12, 2012.
(60) Provisional application No. 61/655,328, filed on Jun. 4, 2012.

(51) Int. Cl. G07F 17/32

(52) U.S. Cl. CPC G07F 17/32
USPC 463/25

(57) ABSTRACT

A computer-implemented method includes determining, by one or more processors, a physical location of a mobile device. The method also includes determining wagering game content associated with the physical location, wherein the wagering game content is for use in presenting at least one wagering game on the mobile device.

### RELATED APPLICATIONS

This application claims the priority benefit of U.S. Provisional Application Ser. No. 61/655,328 filed Jun. 4, 2012 and U.S. Provisional Application Ser. No. 61/700,028 filed Sep. 12, 2012.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### FIELD

Embodiments of the inventive subject matter relate generally to wagering game systems, and more particularly to location aware-based wagering games.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

This type of wagering (e.g., slots games, poker, etc) is not limited to occurring at non-mobile machines at brick-and-mortar wagering game establishments. For example, this type of wagering can also occur online. Additionally, this type wagering is now accessible using different types of devices (including desktop computers, mobile devices, etc.).

### BRIEF DESCRIPTION OF THE FIGURES

Embodiments of the invention are illustrated in the Figures of the accompanying drawings in which:

FIG. 1 depicts a system that provides location-based wagering game content for wagering games based on a physical location of the wagering game machine, according to some embodiments.

FIG. 2 depicts a system that provides wagering game content for wagering games based on a physical location and based on a distance from the position of the wagering game machine from the physical location, according to some embodiments.

FIG. 3 depicts a system that provides wagering game content for wagering games based on a physical location and having a social component, according to some embodiments.

FIGS. 4-5 depict flowcharts of operations for that provide wagering game content for wagering games based on a physical location of the wagering game machine, according to some embodiments.

FIG. 6 depicts a block diagram illustrating a wagering game machine architecture, according to some embodiments.

FIG. 7 depicts a block diagram illustrating a wagering game network, according to some embodiments.

FIG. 8 depicts a wagering game machine, according to some embodiments.

FIG. 9 depicts an image of a base-game screen for a wagering game machine, according to some embodiments.

### DESCRIPTION OF THE EMBODIMENTS

This description of the embodiments is divided into six sections. The first section provides an introduction to some embodiments, while the second section provides a system environment. The third section describes example operations performed by some embodiments. The fourth section describes an example wagering game machine architecture and network environment. The fifth section describes an example wagering game machine and the sixth section presents some general comments.

### Introduction

This section provides an introduction to some embodiments. Some embodiments select wagering game content based on a physical location of a wagering game device. For example, a wagering game player can play a wagering game using an application on their mobile device (e.g., smartphone). The application can present location-based wagering game content for wagering games, where the content is selected (or otherwise modified) based on a physical location of the mobile device.

The physical locations can include areas at or near coffee shops, restaurants, public parks, cities, various landmarks in a city, etc. The physical locations can be associated with one or more business entities, wherein the one or more business entities can sponsor the location-based wagering game content. The location-based wagering game content can affect the play of the wagering game. For example, additional prizes can be awarded for a winning result of the wagering game. These additional prizes can be sponsored by one of the business entities at or near the physical location of the wagering game device when the wagering game is played. To illustrate, the wagering game can be a slots game. If a result is a winning spin in the slots game, the award can include a coupon for a non-monetary award associated with a product or service of the business entity (e.g., a free large coffee if the business entity is a coffee shop). This award from the business entity can be in addition to an award that is traditionally provided by the wagering game for this winning result. Alternatively, this award can be a replacement of an award that is traditionally provided by the wagering game for this winning result. Accordingly, changing the physical location of the wagering game device may change the available prizes.

In some embodiments, multiple wagering games are available for play for at a particular physical location, such as a corner store. For example, wagering game A having prizes M, N, & O, and wagering game B having different prizes X, Y, & Z are both available for play at the corner store. Also, a default wagering game that is not dependent on the physical location may be available. Accordingly, for the corner store, the player can select a wagering game based on the prizes to be won. These different wagering games may or may not have different themes.

In some embodiments, a physical location is associated with multiple business entities. For example, the physical location may be a shopping center having multiple stores. These embodiments enable the player to select from among a number of wagering games, where a game may be associated with different business entities at or near the physical location. For example, a first player at the shopping center may select wagering game A because it offers prizes (e.g., coupons for products or services) from a fashion boutique. A second player at the same shopping center may select wagering game B because it offers prizes from a bike shop.

### System Environment

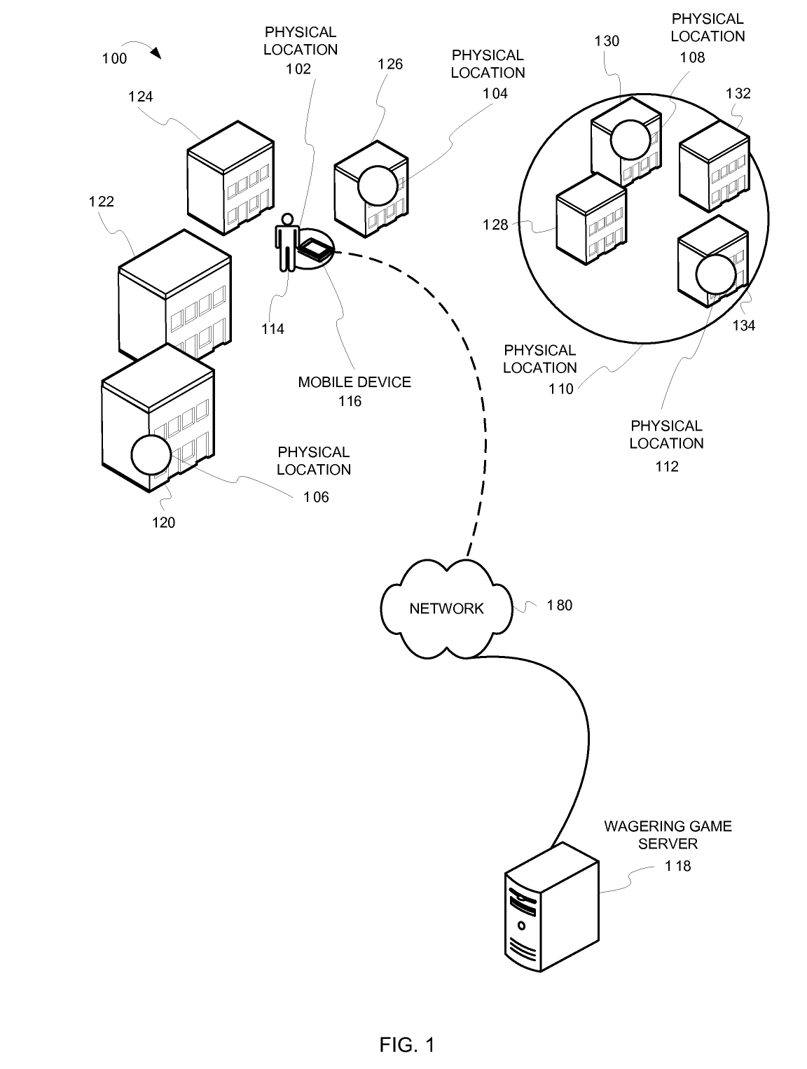

FIG. 1 depicts a system that provides location-based wagering game content for wagering games based on a physical location of the wagering game machine, according to some embodiments. FIG. 1 depicts a system 100 that includes a mobile device 116, a network 180, and a wagering game server 118. The mobile device 116 and the wagering game server 118 are communicatively coupled together through the network 180. In this example, the mobile device 116 includes a wagering game machine. In some embodiments, the mobile device 116 can download location-specific wagering game content from the wagering game server 118. In some other embodiments, the mobile device 116 can have the location-specific wagering game content stored in local machine-readable media, thereby not requiring the content to be downloaded. The mobile device 116 is associated with a person 114. The person 114 is a wagering game player playing wagering games on the mobile device 116.

FIG. 1 also depicts a number of buildings (buildings 120-134) that can represent store fronts for different business entities. While shown as being near or in buildings, the physical locations can be near or in other locations, such as public parks, cities, various landmarks in a city, etc. FIG. 1 also depicts physical locations 102-112. In FIG. 1, the physical location 102 is positioned near but external to the buildings 124-126. The physical location 102 is associated with the business entities in the buildings 124-126. The physical location 104 is positioned within the building 126. The physical location 104 is associated with the business entity in the building 126. The physical location 106 is positioned within the building 120. The physical location 106 is associated with the business entity in the building 120. The physical location 108 is positioned within the building 130. The physical location 108 is associated with the business entity in the building 130. The physical location 110 is positioned to include the buildings 128-134 and some portions external to the buildings 128-134. The physical location 110 is associated with the business entities in the buildings 128-134. The physical location 112 is positioned within the building 134. The physical location 112 is associated with the business entity in the building 134.

In this example, the person 114 and the mobile device 116 are positioned in range of the physical location 102, so that wagering games associated with physical location 102 are available. Therefore, the wagering games associated with the business entities in the buildings 124-126 are playable on the mobile device 116. As the person 114 moves the mobile device 116 to different locations in FIG. 1, wagering games associated with the different physical locations become available for play. For example, when the person 114 moves the mobile device 116 in range of the physical location 104, the person 114 can play wagering games associated with the physical location 104 (e.g., wagering games associated with the business entities in the building 126). When the person moves the mobile device 116 in range of the physical location 106, the person 114 can play wagering games associated with the physical location 106, and so on for all the buildings shown in FIG. 1.

As shown, the size of the physical location can vary. For example, the physical location can be a defined as the area inside or around a building. This can include large buildings (e.g., a baseball stadium) and defined perimeters around large business entities. The physical location can also cover a number of buildings associated with different business entities. The physical location can also include a location near a number of business entities. For example, the physical location can include a park outside a shopping center.

The location-based wagering game content can affect the play of the wagering game. For example, additional prizes can be awarded for a winning result of the wagering game. These additional prizes can be sponsored by one of the business entities that are at or near the physical location of the wagering game device when the wagering game is played. To illustrate, the wagering game can be a slots game. If a result is a winning spin in the slots game, the award can include a coupon for a non-monetary award associated with a product or service of the business entity (e.g., a free large coffee if the business entity is a coffee shop). This award from the business entity can be in addition to an award that is traditionally provided by the wagering game for this winning result. Alternatively, this award can be a replacement of an award that is traditionally provided by the wagering game for this winning result.

The following is an example with reference to the physical locations 108-112. A business entity in the building 128 can be associated with (e.g., sponsor) two different wagering games for the physical location 110. The business entity in the building 130 can be associated with three different wagering games for the physical location 110. A different business entity in the building 130 can also be associated with one wagering game for the physical location 108. The business entity in the building 132 can be associated with three different wagering games for the physical location 110. The business entity in the building 134 can be associated with one wagering game for the physical location 110. A different business entity in the building 134 can also be associated with altered wagering game content for two different wagering games for the physical location 112.

Accordingly, a person can select from multiple wagering games having location-based wagering content for some physical locations. The person can make their selection based on prizes awarded. For example, assume the person 114 moves their mobile device 116 into the physical location 110. The person 114 can initiate a mobile application on the mobile device 116. The mobile device 116 can then present a list of wagering games available for the physical location 110 on its display. The mobile device 116 can also display the available prizes for the wagering games that are available to play. The person 114 can then select which wagering game to play using an input control on the mobile device 116. For example, the person 114 can select a wagering game associated with the business entity in the building 128 because the prizes include coupons for products or services for that business entity.

In some embodiments, the awards for game play based on physical location can also affect subsequent game play at a brick-and-mortar wagering game establishment. For example, the award can be an additional payout for a win at a wagering game machine at a brick-and-mortar wagering game establishment. To illustrate, assume the person is awarded a win for playing a wagering game based on a physical location. The mobile device 116 can then transmit a notification to the wagering game server 118 regarding the additional payout for a win at a wagering game machine at a brick-and-mortar wagering game establishment. The wagering game server 118 can update a player account at the brick-and-mortar establishment for the person 114. Subsequently, when the person 114 has a winning result at a particular wagering game machine (e.g., a wagering game machine having a same theme as the wagering game played on the mobile device 116), an additional award is given for the winning result at the mobile device 116. For example, the additional award can be sponsored by the business entity at the physical location. Such an embodiment incentivizes players to wager at the brick-and-mortar wagering game establishment after playing location-based wagering games. While described in reference to a wagering game machine for a brick-and-mortar wagering game establishment, the example is also applicable to online wagering game machines (e.g., those machines that are part of a virtual wagering game establishment).

The location-based wagering game content can also affect other aspects of the wagering game that is not associated with the play. For example, the location-based wagering game content can affect aspects of the game's presentation (e.g., images, video, audio, etc.). To illustrate, if the wagering game is a slots game, one or more of the reel symbols can be modified to represent the physical location. For example, the physical locations can be associated with a business entity, a government entity, a geographic location, etc. In such configurations, the location-based wagering game content can include graphics or images representing the associated business entity, government entity, geographic location, etc. Also, wagering can include wagering of real money, “fun” money, or anything else of real or perceived value on an event with an uncertain outcome. For example, the wagering could be based on a virtual currency, where the wagering games are played for fun. In such an example, the rewards could be discounts for services or products for a business entity.

Some embodiments herein are described such that certain operations are performed by a wagering game module in a mobile device (e.g., determining wagering game content associated with a physical location where the mobile device is positioned). However, in some embodiments, these operations can be performed by the wagering game server 118 or other device communicatively coupled to the mobile device.

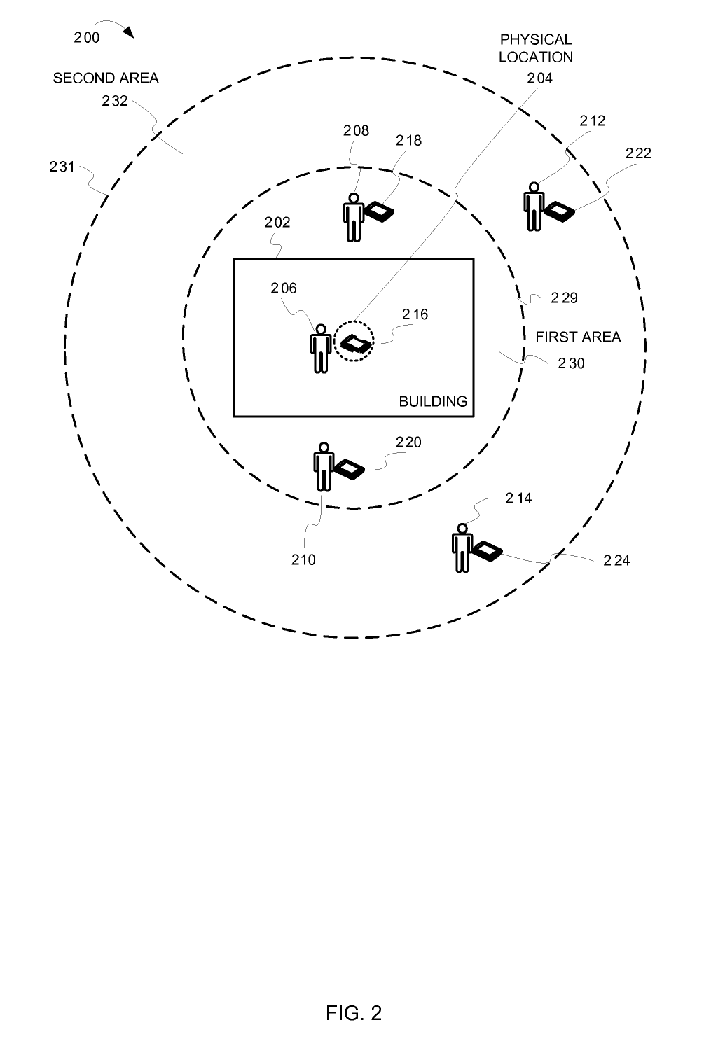

In some embodiments, the mobile device is not required to be within the area defined as the physical location. Rather if the mobile device is within a range of the physical location, wagering games based on the physical location are available (i.e., playable range). Prizes can vary based on mobile device's proximity to the physical location. In some embodiments, the closer the mobile device is to the physical location, the greater the prizes can be. For example, assume the location is inside a store. If the mobile device is within the store, prizes greater than $50 can be awarded. If outside the store but within 50 feet, prizes between $25 and $50 can be awarded. If outside the store but within 100 feet, prizes up to $25 can be awarded. If greater than 100 feet, the wagering game is not available for play. To illustrate, FIG. 2 depicts a system that provides wagering game content for wagering games based on a physical location and based on a distance from the position of the wagering game machine from the physical location, according to some embodiments.

FIG. 2 depicts a system 200 that includes mobile devices 216-224 and a physical location 204 that is within a building 202. The building 202 can be a store front, stadium, a government building, etc. A person 206 is associated with the mobile device 216. A person 208 is associated with the mobile device 218. A person 210 is associated with the mobile device 220. A person 212 is associated with the mobile device 222. A person 214 is associated with the mobile device 224. FIG. 2 also depicts two areas (area 230 and area 232) that radiate outward from the physical location 204. The area 230 and the area 232 define two “playable areas”. The area 230 includes an area between the ring defining location 204 and ring 229. The area 232 includes an area between the ring 229 and ring 231.

Wagering games associated with the physical location 204 are playable on mobile devices even though the mobile devices are outside the physical location 204. In particular, the wagering games are playable as long as the mobile devices are within the outermost area 232.

In some embodiments, the person 206 can play at least one wagering game in a first group of wagering games on the mobile device 216, because the mobile device 216 is in the physical location 204. The person 208 can play at least one wagering game in a second group of wagering games on the mobile device 218, because the mobile device 218 is within the first area 230. That is, in some embodiments, because the mobile device 218 is within a certain distance from the physical location 204, the second group of wagering games is available on the device 218. The person 210 can also play at least one wagering game in the second group of wagering games on the mobile device 220, because the mobile device 220 is within the first area 230 of the physical location 204. The person 212 can play at least one wagering game in a third group of wagering games on the mobile device 222, because the mobile device 222 is within the second area 232 of the physical location 204. The person 214 can also play at least one wagering game in the third group of wagering games on the mobile device 224, because the mobile device 224 is within the first distance 232 of the physical location 204.

In this example, the prizes vary based on mobile device's proximity to the physical location 204. In some embodiments, the closer the mobile device is to the physical location 204, the greater the prizes can be. For example, because the mobile device 216 is within the physical location 204, the person 206 can play win prizes that can be at least $50 defined for a first group of wagering games. Because the mobile devices 218-220 are beyond the physical location 204 but within the first area 230, the persons 208-210 can win prizes that can be between $25 and $50 defined for a second group of wagering games. Because the mobile devices 222-224 are beyond the first area 230 but within the second area 232, the persons 212-214 can win prizes that can be up to $25 defined for a third group of wagering games. If the mobile device is outside the second area, no wagering games are available to play for the physical location 204. Such a configuration incentivizes persons to be closer to the physical location, which could cause the persons to buy products and services from the business entity in the building 202.

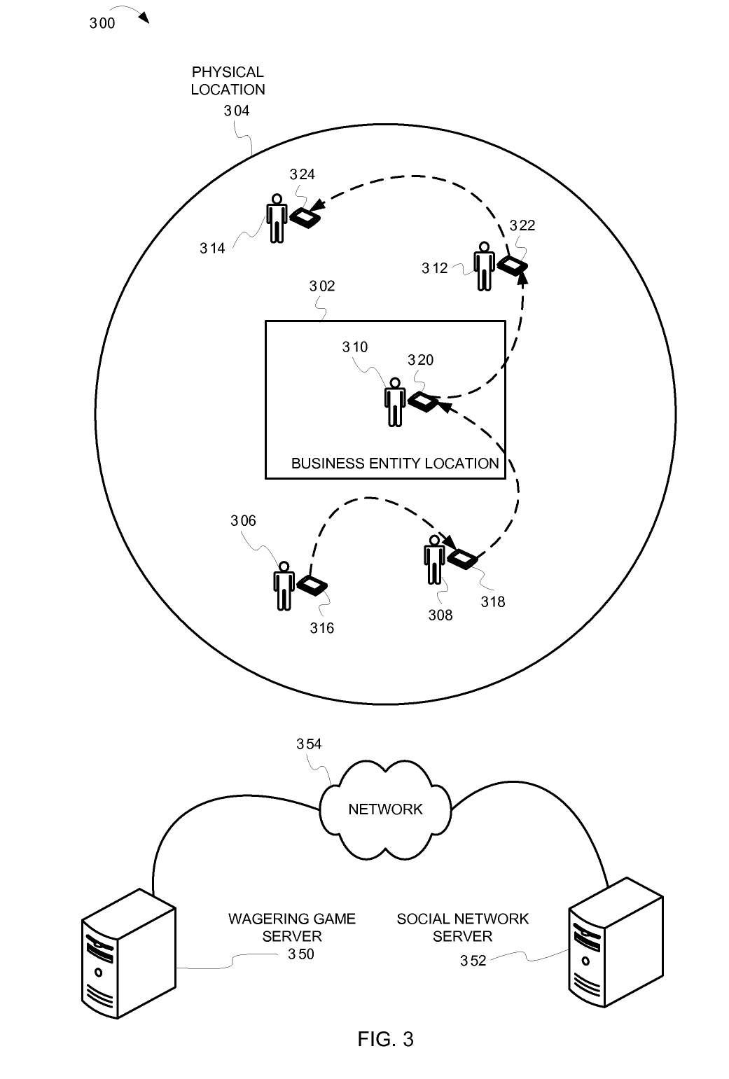

Some embodiments incorporate a social component into the wagering games. In particular, FIG. 3 depicts a system that provides wagering game content for wagering games based on a physical location and having a social component, according to some embodiments. FIG. 3 depicts a system 300 wherein a social game is played by a group within a social network. A group win of the social game occurs when a defined number of persons achieve a winning result for a wagering game on their mobile devices. That is, to achieve a group win each person in a social network group must have a winning result on their mobile device. The group win can be a shared award that is sponsored by a business entity associated with the physical location. For example, if the business entity is a professional sports team, the award can be tickets for a stadium suite for a game.

The system 300 includes mobile devices 316-324 and a physical location 304 that is includes a building 302. The system 300 also includes a wagering game server 350 and a social network server 352 that communicate with the mobile devices 316-324 through a network 354. The building 302 can be a store front, stadium, a government building, etc. A person 306 is associated with the mobile device 316. A person 308 is associated with the mobile device 318. A person 310 is associated with the mobile device 320. A person 312 is associated with the mobile device 322. A person 314 is associated with the mobile device 324. As shown, the persons 306-314 have their mobile devices 316-322 within the physical location 304.

In FIG. 3, the persons 306-314 are part of a group within a social network (e.g., Facebook). For example, the persons 306-314 can be a defined group of Facebook friends. FIG. 3 shows how some embodiments employ player forwarding (see dotted arrow begging at 316) to provide access to the social component of the wagering game. After a person achieves a winning result for a wagering game, the person initiates an operation to cause the mobile device to transmit a notification to a different person in the group that has not yet achieved a winning result (i.e., player forwarding). The player forwarding continues until each person in the group has achieved a winning result for the social component of the wagering game. After each person in the group has achieved a winning result, a group win is awarded to the members of the group.

In FIG. 3, the person 306 using the mobile device 316 is provided initial access to a wagering game with the social component. The mobile device 316 may obtain initial access through a random determination. For example, the person 306 can initiate a mobile application on the mobile device 316 to view the available wagering games based on the current location of the mobile device 316. The mobile device 316 can wirelessly communicate with the wagering game server 350. The wagering game server 350 can make a random determination and transmit the result to the mobile device 316. If the mobile device 316 is selected, the mobile application can provide a wagering game having a social component to the mobile device 316. The mobile application may download the wagering game content for the social component from the wagering game server 350 and/or retrieve it from a local machine-readable storage device in the mobile device 316.

Also, the mobile application on the mobile device 316 can communicate with the social network server 352 using an Application Programming Interface (API). The mobile application can access the account for the person 306 for the social network being hosted by the social network server 352. The mobile application can retrieve a list of groups from the account of the person 306. The mobile application can then randomly select a group that is to be part of the social game. Alternatively, the person 306 can be presented an option to select a group from their social network. Alternatively, the person 306 can create a group on their social network. After the group is selected or created, the persons within the group can then have the option to play the wagering game having the social component.

In FIG. 3, after achieving a winning result, the person 306 causes the mobile device 316 to send a notification to the mobile device 318. The person 308 then plays the wagering game until there is a winning result for the social component. After achieving a winning result, the person 308 causes the mobile device 318 to send a notification to the mobile device 320. The person 310 then plays the wagering game until there is a winning result for the social component. After achieving a winning result, the person 310 causes the mobile device 320 to send a notification to the mobile device 322. The person 312 then plays the wagering game until there is a winning result for the social component. After achieving a winning result, the person 312 causes the mobile device 322 to send a notification to the mobile device 324. The person 314 then plays the wagering game until there is a winning result for the social component. After the person 314 achieves a winning result, a group win is awarded to the members of the group (the persons 306-314).

In some embodiments, mobile devices do not send notifications to each other. Instead, after a mobile device achieves a winning result, the mobile device transmits a communication to the social network server. For example, the mobile device may post a notification on the wall of at least one member in the group who has not yet achieved a winning result for the wagering game. Also, as each winning result is achieved and/or after the group win is awarded, the mobile device can post a notification on the wall of each member of the group in the social network.

### Example Operations

This section describes operations associated with some embodiments. In the discussion below, the flowcharts will be described with reference to the block diagrams presented above. However, in some embodiments, the operations can be performed by logic not described in the block diagrams.

In certain embodiments, the operations can be performed by executing instructions residing on machine-readable storage device, while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flowchart.

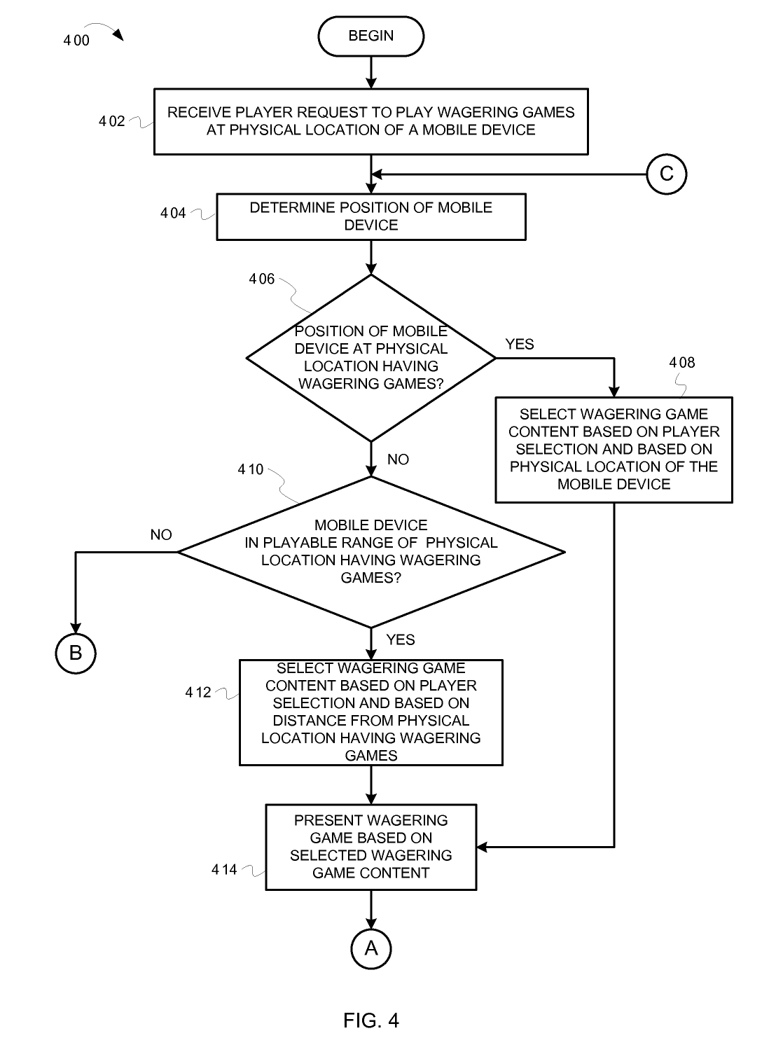

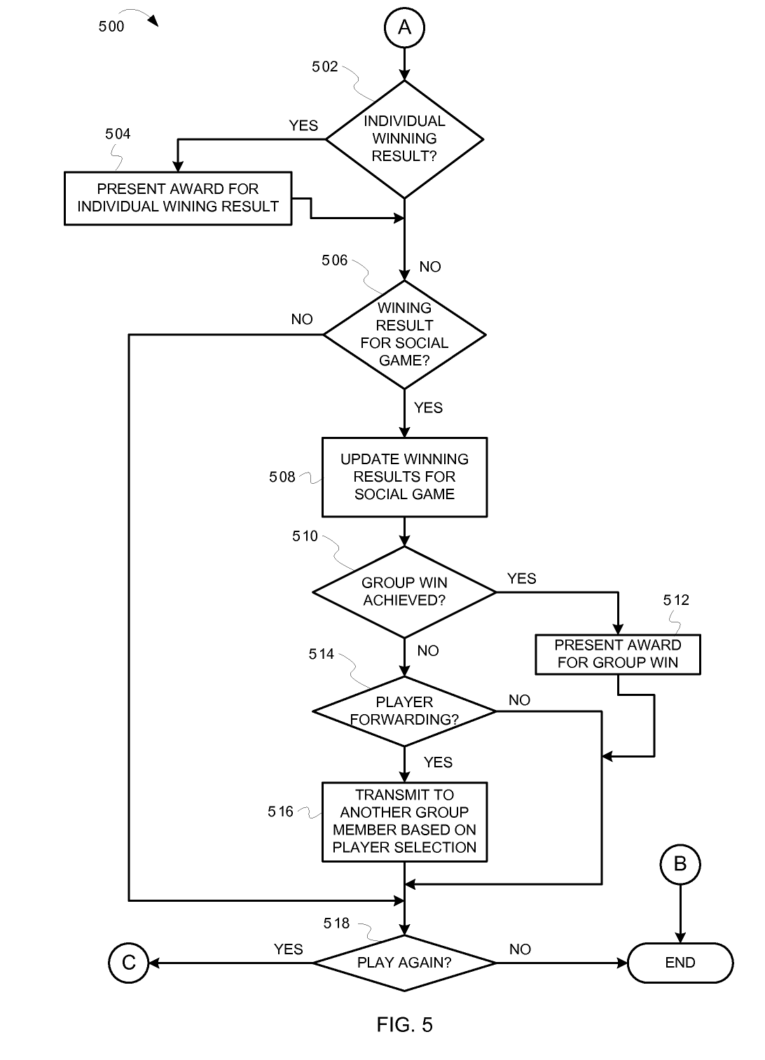

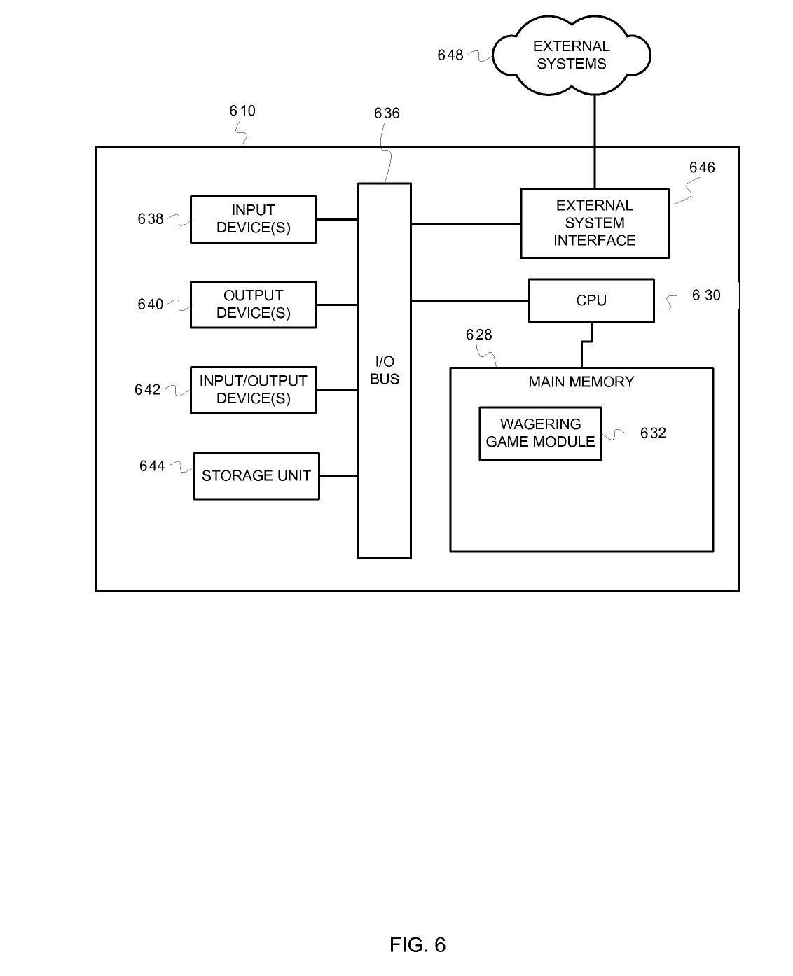

FIGS. 4-5 depict flowcharts of operations for that provide wagering game content for wagering games based on a physical location of the wagering game machine, according to some embodiments. The operations of a flowchart 400 and a flowchart 500 are described in reference to FIGS. 1-3. The operations of the flowchart 400 and the flowchart 500 are performed together and continue between each other as defined by transition points A, B, and C. The operations of the flowcharts 400 and 500 may be performed by a wagering game module executing in a mobile device (e.g., the mobile device 116 of FIG. 1). The wagering game module can present the mobile application to the wagering game player on the mobile device (as described above). The wagering game module can be software, hardware, firmware or a combination thereof executing in a mobile device. The mobile device can include a wagering game machine that presents wagering games for play by a wagering game player. An example architecture of such a wagering game machine is described in more detail below in reference to FIG. 6. The operations of the flowcharts 400 and 500 begin at block 402 of FIG. 4.

At block 402, the wagering game module receives a player request to play wagering games at a physical location of a mobile device. With reference to FIG. 1, the person 114 can initiate a mobile application on the mobile device 116. Operations of the flowchart 400 continue at block 404.

At block 404, the wagering game module determines the position of the mobile device. With reference to FIG. 1, the mobile device 116 can include a Global Positioning System (GPS) module that provides a position of the mobile device 116. The wagering game module can receive the position of the mobile device 116 from the GPS module. Operations of the flowchart 400 continue at block 406.

At block 406, the wagering game module determines whether position of mobile device is at physical location having wagering games. With reference to FIG. 1, the wagering game module determines whether the position of the mobile device 116 is at a physical location having wagering games. For example, this determination can be made based on a comparison of position coordinates of the mobile device 116 and position coordinates defined for physical locations having wagering games. In some embodiments, the wagering game module requests the identification of any physical locations near the mobile device 116 from the wagering game server 118. Alternatively, the positions of physical locations having wagering games can be stored in machine-readable storage device in the mobile device 116. Accordingly, the wagering game module can retrieve the positions of the physical locations from its own storage device. As the position of mobile device 116 changes, the wagering game module can download the positions of the physical locations near the wagering game machine 116. This download can be a low priority communication. This downloaded data can then be stored in machine-readable storage device in the mobile device 116 for subsequent use. Then, in response to the person 114 making the request to play wagering games for any physical locations, the wagering game module can retrieve this data from machine-readable storage media in the mobile device 116. If the position of the mobile device is at a physical location having wagering games, operations of the flowchart 400 continue at block 408. Otherwise, operations of the flowchart 400 continue at block 410.

At block 408, the wagering game module selects wagering game content based on player selection and based on the physical location of the mobile device. With reference to FIG. 1, the wagering game module can present a list of wagering games available for the physical location 110 on a display of the mobile device 116. The wagering game module can also display the available prizes for the wagering games that are available to play. The person 114 can then select which wagering game to play using an input control on the mobile device 116. For example, the person 114 can select a wagering game associated with the business entity in the building 128. Operations of the flowchart 400 continue at block 414.

At block 410, the wagering game module determines whether the mobile device is in playable range of a physical location having wagering games. With reference to FIG. 2 as described above, wagering games can be available for play for a physical location 216 even though the mobile device is not at the physical location. In particular, there can be different areas beyond the physical location 216 where wagering games associated with the physical location 216 are still available. Accordingly, the wagering game module determines if there are any such areas. The wagering game module then determines if the current position of the mobile device is within such an area. With reference to FIG. 2, the wagering game module determines whether the mobile device is within a first area 230. If beyond the first area 230, the wagering game module then determines whether the mobile device is within the second area (defined between the lines 229 and 231). If the mobile device is within a playable area, operations of the flowchart 400 continue at block 412. Otherwise, operations of the flowchart 400 continue at transition point B, which continues at transition point B of the flowchart 500.

At block 412, the wagering game module selects wagering game content based on player selection and based on distance from physical location having wagering games. With reference to FIG. 2, assume for this example that the mobile device is the mobile device 220. The wagering game module can present a list of wagering games available for the physical location 204 for the first area 230. The wagering game module can also display the available prizes for the wagering games that are available to play. The person 210 can then select which wagering game to play using an input control on the mobile device 220. Operations of the flowchart 400 continue at block 414.

At block 414, the wagering game module presents a wagering game based on content selected earlier in the flow 400. In some instances where the content is selected based on physical location, the wagering game content can include prizes that are associated with the physical location. These prizes can be a substitution for prizes defined by wagering game content not associated with the physical location. Alternatively, these different prizes can be an addition to the prizes defined by the wagering game content not associated with the physical location. In some embodiments, the pay tables that determine wins do not change between the non-location-based wagering game content and the location-based wagering game content. Therefore, the prizes can vary for a same pay table. In some embodiments, the location-based wagering game content can affect aspects of the game's presentation (e.g., images, video, audio, etc.). To illustrate, if the wagering game is a slots game, one or more of the reel symbols can be modified to represent the physical location. For example, the physical locations can be associated with a business entity, a government entity, a geographic location, etc. In such configurations, the location-based wagering game content can be graphics or images that represent the associated business entity, government entity, geographic location, etc. Operations of the flowchart 400 continue at transition point A, which continue at transition point A of the flowchart 500.

The flowchart 500 is now described. Operations of the flowchart 500 begin at the transition point A, which continue at block 502.

At block 502, the wagering game module determines whether there is an individual winning result from play of the wagering game. As described below, a result of the wagering game can be a result for a group win for wagering games having a social component. The result for a group win can be in addition to an individual winning result. Alternatively, the result for a group win can be in substitution of an individual winning result. Therefore, the wagering game module determines whether the win is an individual winning result and/or a group winning result. For a slots games, the winning result can be a winning combination of the visible pattern of symbols after the reels have stopped. For a poker game, the winning result can be a winning hand (e.g., full house). If there is a winning result, operations of the flowchart 500 continue at block 504. Otherwise, operations of the flowchart 500 continue at block 506.

At block 504, the wagering game module presents award for individual winning result of the wagering game. The award can vary based on the physical location or distance from the physical location. The award can also be sponsored by a business entity at or near the physical location. The award can be monetary or non-monetary. For example, the award can include a coupon for a non-monetary award associated with a product or service of the business entity (e.g., a free large coffee if the business entity is a coffee shop). This award from the business entity can be in addition to an award that is traditionally provided by the wagering game for this winning result. Alternatively, this award can be a replacement of an award that is traditionally provided by the wagering game for this winning result. The award can be presented electronically (e.g., at the mobile device). The player can then present for redemption at the business entity. The mobile device could also transmit a communication to a server associated with the business entity. In response, the business entity can provide a physical coupon or the product/service to the person. Operations of the flowchart 500 continue at block 506.

At block 506, the wagering game module determines whether there is a winning result for a social game for the wagering game. As described in reference to FIG. 3, wagering games can include a social component, wherein winning results by members of a group in a social network result in a group win. The group winning result can be the same or different from the individual winning result. If there is a winning result for a social game for the wagering game, operations of the flowchart 500 continue at block 508. Otherwise, operations of the flowchart 500 continue at block 518.

At block 508, the wagering game module updates winning results for the social game. With reference to FIG. 3, the wagering game module can transmit a communication to the wagering game server 350 about the winning result for the social game. The wagering game server 350 can track if the required number of members for a social group has achieved a winning result to award a group win. Operations of the flowchart 500 continue at block 510.

At block 510, the wagering game module determines whether a group win has been achieved. With reference to FIG. 3, the wagering game module can receive a communication from the wagering game server 350 that notifies that a group win is achieved based on this winning result. If a group win has been achieved, operations of the flowchart 500 continue at block 512. Otherwise, operations of the flowchart 500 continue at block 514.

At block 512, the wagering game module presents award for the group win. Similar to the individual winning result, the award for the group win can vary based on the physical location or distance from the physical location. The award can also be sponsored by a business entity at or near the physical location. The award can be monetary or non-monetary. For example, if the business entity is a professional sports team, the award can be tickets for a stadium suite for a game. The award can be presented electronically where the player can present for redemption at the business entity. The mobile device could also transmit a communication to a server associated with the business entity. In response, the business entity can provide a physical coupon or the product/service to the person. With reference to FIG. 3, the wagering game server 350 can also notify all other members in the group that the group win was achieved. For example, the wagering game server 350 can transmit a communication to the mobile devices of each member of the group. The wagering game server 350 can also post the group win notification on the wall of each member of the group in the social network. Operations of the flowchart 500 continue at block 518.

At block 514, the wagering game module determines whether the social game includes player forwarding. As described above in reference to FIG. 3, for some social games, after achieving a winning result, a member forwards notification of their winning result to a different member of the social group that has not yet achieved a winning result. Accordingly, the wagering game module determines whether this social game having the winning result includes player forwarding to other group members. If there is player forwarding, operations of the flowchart 500 continue at block 516. Otherwise, operations of the flowchart 500 continue at block 518.

At block 516, the wagering game module transmits a notification of the winning result to another member in the social group that has not yet achieved a winning result for the wagering game at the physical location. Operations of the flowchart 500 continue at block 518.

At block 518, the wagering game module determines whether the wagering game player wants to play again. The wagering game module can present the option to play again on a display of the mobile device. The wagering game player can then select an input on the mobile device to indicate if they want to play again. If the wagering game player wants to play again, operations of the flowchart 500 continue at transition point C, which continue at transition point C of the flowchart 400. Otherwise, operations of the flowchart 500 are complete.

Wagering Game Machine Architecture and Network Environment

This section describes an example wagering game architecture and network environment of some embodiments.

### Wagering Game Machine Architecture

FIG. 6 depicts a block diagram illustrating a wagering game machine architecture, according to some embodiments. The gaming terminal 610 includes a central processing unit (CPU) 630 connected to a main memory 632. The CPU 630 may include any suitable processor(s), such as those made by Intel and AMD. By way of example, the CPU 630 includes a plurality of microprocessors including a master processor, a slave processor, and a secondary or parallel processor. CPU 630, as used herein, comprises any combination of hardware, software, or firmware disposed in or outside of the gaming terminal 610 that is configured to communicate with or control the transfer of data between the gaming terminal 610 and a bus, another computer, processor, device, service, or network. The CPU 630 comprises one or more controllers or processors and such one or more controllers or processors need not be disposed proximal to one another and may be located in different devices or in different locations. The CPU 630 is operable to execute all of the various gaming methods and other processes disclosed herein. The main memory 628 includes a wagering game module 632. In one embodiment, the wagering game module 632 may present wagering games, such as video poker, video black jack, video slots, video lottery, etc., in whole or part. In some embodiments, the wagering game module performs operations for presenting wagering games based on location-based wagering game content (as described above).

The CPU 630 is also connected to an input/output (I/O) bus 636, which can include any suitable bus technologies, such as an AGTL+ frontside bus and a PCI backside bus. The I/O bus 636 is connected to various input devices 638, output devices 640, and input/output devices 642. The I/O bus 636 is also connected to storage unit 644 and external system interface 646, which is connected to external system(s) 648 (e.g., wagering game networks).

The external system 648 includes, in various aspects, a gaming network, other gaming terminals, a gaming server, a remote controller, communications hardware, or a variety of other interfaced systems or components, in any combination. In yet other aspects, the external system 648 may comprise a player's portable electronic device (e.g., cellular phone, electronic wallet, etc.) and the external system interface 646 is configured to facilitate wireless communication and data transfer between the portable electronic device and the CPU 630, such as by a near-field communication path operating via magnetic-field induction or a frequency-hopping spread spectrum RF signals (e.g., Bluetooth, etc.).

The gaming terminal 610 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 648 (“thin client” gaming terminal), or are distributed therebetween in any suitable manner (“intermediate client” gaming terminal).

Any component of the gaming terminal architecture may include hardware, firmware, or tangible machine-readable storage devices including instructions for performing the operations described herein. Machine-readable storage devices include any mechanism that stores information and provides the information in a form readable by a machine (e.g., gaming terminal, computer, etc.). For example, machine-readable storage devices include semiconductor read only memory (ROM), semiconductor random access memory (RAM), magnetic disk storage media, optical storage media, flash memory, etc.

### Wagering Game Network

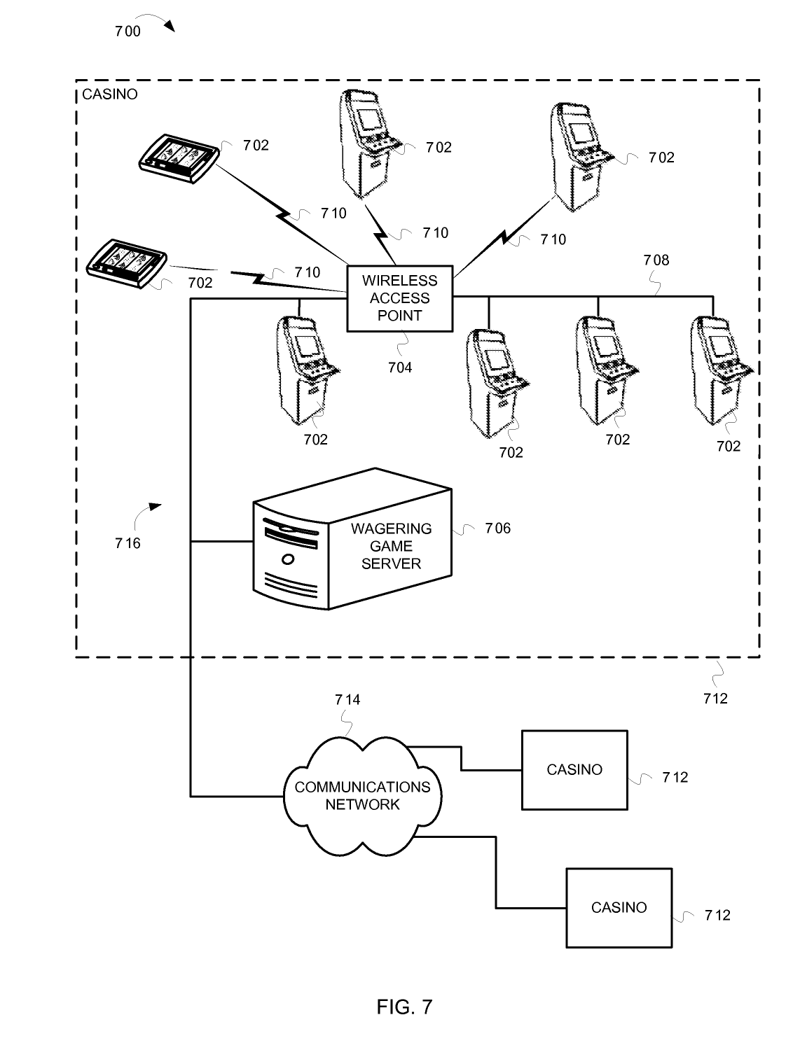

FIG. 7 depicts a block diagram illustrating a wagering game network, according to some embodiments. As shown in FIG. 7, the wagering game network 700 includes a plurality of casinos 712 connected to a communications network 714.

Each casino 712 includes a local area network 716, which includes an access point 704, a wagering game server 706, and wagering game machines 702. The access point 704 provides wireless communication links 710 and wired communication links 708. The wired and wireless communication links can employ any suitable connection technology, such as Bluetooth, 802.11, Ethernet, public switched telephone networks, SONET, etc. In some embodiments, the wagering game server 706 can serve wagering games and distribute content to devices located in other casinos 712 or at other locations on the communications network 714.

The wagering game machines 702 described herein can take any suitable form, such as floor standing models, handheld mobile units, bartop models, workstation-type console models, etc. Further, the wagering game machines 702 can be primarily dedicated for use in conducting wagering games, or can include non-dedicated devices, such as mobile phones, personal digital assistants, personal computers, etc. In one embodiment, the wagering game network 700 can include other network devices, such as accounting servers, wide area progressive servers, player tracking servers, and/or other devices suitable for use in connection with embodiments of the invention.

In some embodiments, wagering game machines 702 and wagering game servers 706 work together such that a wagering game machine 702 can be operated as a thin, thick, or intermediate client. For example, one or more elements of game play may be controlled by the wagering game machine 702 (client) or the wagering game server 706 (server). Game play elements can include executable game code, lookup tables, configuration files, game outcome, audio or visual representations of the game, game assets or the like. In a thin-client example, the wagering game server 706 can perform functions such as determining game outcome or managing assets, while the wagering game machine 702 can present a graphical representation of such outcome or asset modification to the user (e.g., player). In a thick-client example, the wagering game machines 702 can determine game outcomes and communicate the outcomes to the wagering game server 706 for recording or managing a player's account. In some embodiments, the wagering game machines 702 can have handheld devices and can be part of communal event (as described above).

In some embodiments, either the wagering game machines 702 (client) or the wagering game server 706 can provide functionality that is not directly related to game play. For example, account transactions and account rules may be managed centrally (e.g., by the wagering game server 706) or locally (e.g., by the wagering game machine 702). Other functionality not directly related to game play may include power management, presentation of advertising, software or firmware updates, system quality or security checks, etc.

In some embodiments, the wagering game server 706 can host online wagering games, such as by hosting one or more online wagering game websites. Players can sign-on to such websites and play wagering games via web browsers, client applications, etc. In some embodiments, online gaming functionality is performed by an online gaming server (not shown), where the online gaming server does not determine results for the wagering game machines 702.

Any of the wagering game network components (e.g., the wagering game machines 702) can include hardware and machine-readable media including instructions for performing the operations described herein.

### Example Wagering Game Machine

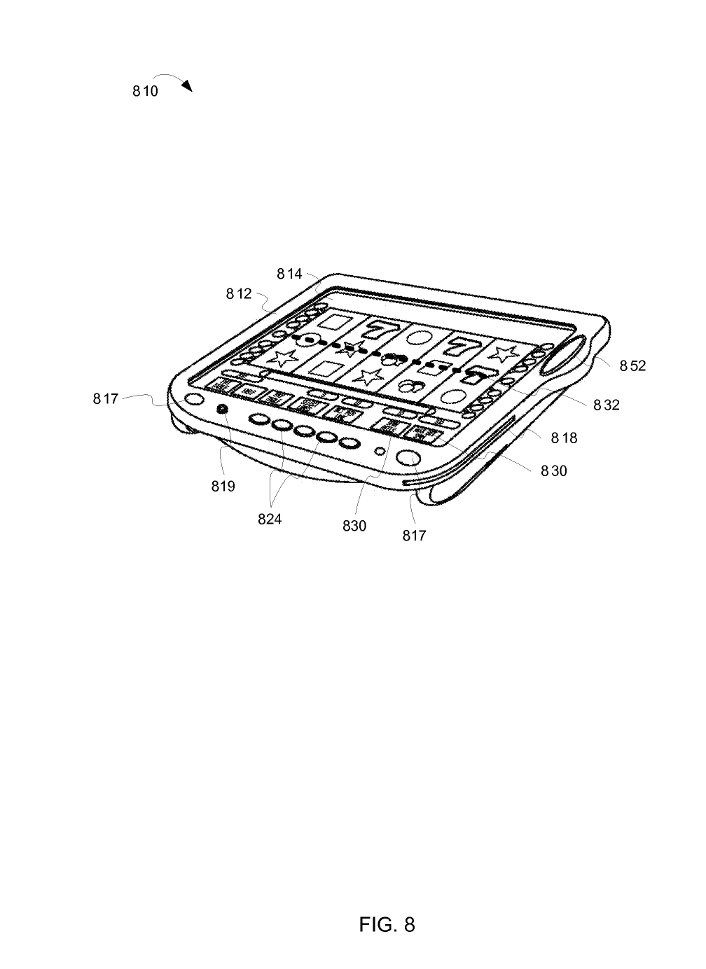

FIG. 8 depicts a wagering game machine, according to some embodiments. In this embodiment, the wagering game machine is a mobile device 810. The mobile device 810 can be a smartphone, tablet, etc. Like large cabinet-type wagering game machines, the mobile device 810 can include any suitable electronic device configured to play a video casino games such as blackjack, slots, keno, poker, blackjack, and roulette. The mobile device 810 comprises a housing 812 and includes input devices, including a value input device 818 and a player input device 824. For output, the mobile device 810 includes a display 814, one or more speakers 817, one or more player-accessible ports 819 (e.g., an audio output jack for headphones, a video headset jack, etc.), and other conventional I/O devices and ports, which may or may not be player-accessible. The display 814 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and mobile device status.

The player-accessible value input device 818 can comprise, for example, a slot located on the front, side, or top of the casing 812 configured to receive credit from a stored-value card (e.g., casino card, smart card, debit card, credit card, etc.) inserted by a player. The player-accessible value input device 818 can also comprise a sensor (e.g., an RF sensor) configured to sense a signal (e.g., an RF signal) output by a transmitter (e.g., an RF transmitter) carried by a player. The player-accessible value input device 818 can also or alternatively include a ticket reader, or barcode scanner, for reading information stored on a credit ticket, a card, or other tangible portable credit or funds storage device. The credit ticket or card can also authorize access to a central account, which can transfer money to the mobile device 810.

Still other player-accessible value input devices 818 can require the use of touch keys 830 on the touch-screen display (e.g., display 814) or player input devices 824. Upon entry of player identification information and, preferably, secondary authorization information (e.g., a password, PIN number, stored value card number, predefined key sequences, etc.), the player can be permitted to access a player's account. As one potential optional security feature, the mobile device 810 can be configured to permit a player to only access an account the player has specifically set up for the mobile device 810. Other conventional security features can also be utilized to, for example, prevent unauthorized access to a player's account, to minimize an impact of any unauthorized access to a player's account, or to prevent unauthorized access to any personal information or funds temporarily stored on the mobile device 810.

The player-accessible value input device 818 can itself comprise or utilize a biometric player information reader which permits the player to access available funds on a player's account, either alone or in combination with another of the aforementioned player-accessible value input devices 818. In an embodiment wherein the player-accessible value input device 818 comprises a biometric player information reader, transactions such as an input of value to the mobile device 810, a transfer of value from one player account or source to an account associated with the mobile device 810, or the execution of another transaction, for example, could all be authorized by a biometric reading, which could comprise a plurality of biometric readings, from the biometric device.

Alternatively, to enhance security, a transaction can be optionally enabled only by a two-step process in which a secondary source confirms the identity indicated by a primary source. For example, a player-accessible value input device 818 comprising a biometric player information reader can require a confirmatory entry from another biometric player information reader 852, or from another source, such as a credit card, debit card, player ID card, fob key, PIN number, password, hotel room key, etc. Thus, a transaction can be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 818 can be provided remotely from the mobile device 810.

The player input device 824 comprises a plurality of push buttons on a button panel for operating the mobile device 810. In addition, or alternatively, the player input device 824 can comprise a touch screen mounted to the display 814. In one aspect, the touch screen is matched to a display screen having one or more selectable touch keys 830 selectable by a user's touching of the associated area of the screen using a finger or a tool, such as a stylus pointer. A player enables a desired function either by touching the touch screen at an appropriate touch key 830 or by pressing an appropriate push button on the button panel. The touch keys 830 can be used to implement the same functions as push buttons. Alternatively, the push buttons 826 can provide inputs for one aspect of the operating the game, while the touch keys 830 can allow for input needed for another aspect of the game. The various components of the mobile device 810 can be connected directly to, or contained within, the casing 812, as seen in FIG. 8, or can be located outside the casing 812 and connected to the casing 812 via a variety of wired (tethered) or wireless connection methods. Thus, the mobile device 810 can comprise a single unit or a plurality of interconnected (e.g., wireless connections) parts which can be arranged to suit a player's preferences.

The operation of the basic wagering game on the mobile device 810 is displayed to the player on the display 814. The display 814 can also display the bonus game associated with the basic wagering game. The display 814 preferably takes the form of a high resolution LCD, a plasma display, an LED, or any other type of display suitable for use in the mobile device 810. The size of the display 814 can vary from, for example, about a 2-3″ display to a 15″ or 17″ display. In at least some embodiments, the display 814 is a 7″-10″ display. In one embodiment, the size of the display can be increased. Optionally, coatings or removable films or sheets can be applied to the display to provide desired characteristics (e.g., anti-scratch, anti-glare, bacterially-resistant and anti-microbial films, etc.). In at least some embodiments, the display 814 can have a 16:9 aspect ratio or other aspect ratio (e.g., 4:3). The display 814 can also have different resolutions, different color schemes, and different aspect ratios.

As with the free standing embodiments a wagering gaming machine, a player begins play of the basic wagering game on the mobile device 810 by making a wager (e.g., via the value input device 818 or an assignment of credits stored on the handheld gaming machine via the touch screen keys 830, player input device 824, or buttons 826) on the mobile device 810. In some embodiments, the basic game can comprise a plurality of symbols arranged in an array, and includes at least one payline 832 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 818 of the mobile device 810 can double as a player information reader 852 that allows for identification of a player by reading a card with information indicating the player's identity (e.g., reading a player's credit card, player ID card, smart card, etc.). The player information reader 852 can alternatively or also comprise a bar code scanner, RFID transceiver or computer readable storage medium interface. In one embodiment, the player information reader 852 comprises a biometric sensing device.

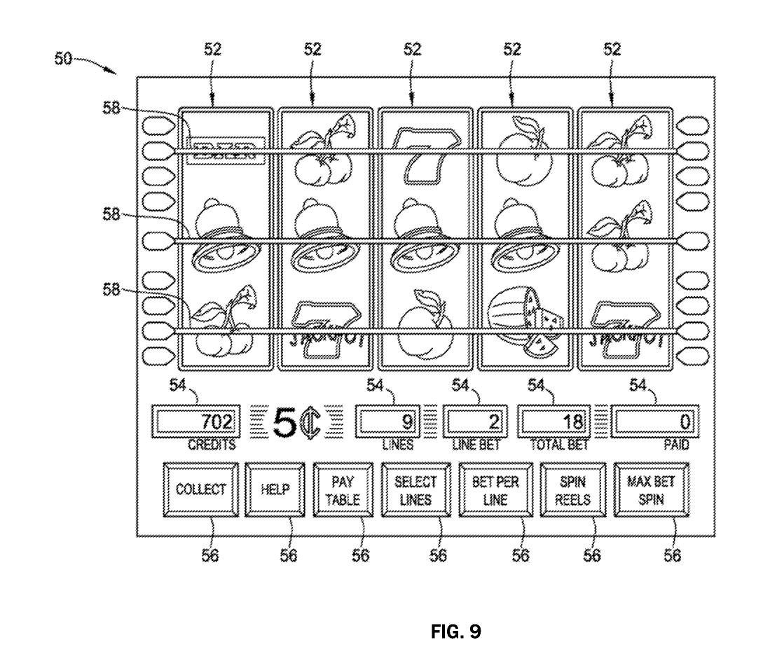

FIG. 9 depicts an image of a base-game screen for a wagering game machine, according to some embodiments. Referring to FIG. 9, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 8. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 1030) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 1044), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A computer-implemented method comprising:
determining, by one or more processors, a physical location of a mobile device; and
determining wagering game content associated with the physical location, wherein the wagering game content is for use in presenting at least one wagering game on the mobile device.

2. The computer-implemented method of claim 1, further comprising presenting, using the wagering game content, the wagering game on the mobile device.

3. The computer-implemented method of claim 1, further comprising:
receiving a selection of a first wagering game of the at least one wagering game;
presenting the first wagering game, wherein the first wagering game is sponsored by a first business entity;
receiving a selection of a second wagering game of the at least one wagering game; and
presenting the second wagering game, wherein the second wagering game is sponsored by a second business entity.

4. The computer-implemented method of claim 1, wherein the physical location is associated with a business entity, and wherein a portion of the wagering game content is sponsored by the business entity.

5. The computer-implemented method of claim 4, wherein the portion of the wagering game content that is sponsored by the business entity comprises a prize awarded as a result of play of the at least one wagering game.

6. The computer-implemented method of claim 5, wherein the prize comprises at least one non-monetary award selected from a group consisting of a product and a service of the business entity.

7. The computer-implemented method of claim 1, further comprising:
determining a winning result for the at least one wagering game by a first wagering game player;
in response to the winning result,
inviting a second wagering game player to play the at least one wagering game, wherein the first wagering game player and the second wagering game player are part of a group in a social network, and
awarding a group prize after all in the group have achieved winning results for the at least one wagering game.

8. A computer-implemented method comprising:
determining, by one or more processors, a position of a mobile device;
determining, a distance of the position of the mobile device to a physical location; and
selecting wagering game content for use in presenting at least one wagering game, wherein the selecting is based on the distance of the position of the mobile device to the physical location.

9. The computer-implemented method of claim 8, further comprising presenting, using the wagering game content, the at least one wagering game.

10. The computer-implemented method of claim 8, wherein the wagering game content comprises prizes awarded as a result of play of the at least one wagering game, wherein a value of the prize increases as the position of the mobile device is closer to the physical location.

11. The computer-implemented method of claim 10, wherein the physical location is associated with a business entity, and wherein a portion of the wagering game content is sponsored by the business entity.

12. The computer-implemented method of claim 11, wherein the prize comprises at least one non-monetary award selected from a group consisting of a product and a service of the business entity.

13. The computer-implemented method of claim 8, further comprising:
determining a winning result for the at least one wagering game by a first wagering game player;
in response to the winning result,
inviting a second wagering game player to play the at least one wagering game, wherein the first wagering game player and the second wagering game player are part of a group in a social network, and
awarding a group prize after all in the group have achieved winning results for the at least one wagering game.

14. An apparatus comprising:
at least one display device;
at least one processor; and
at least one memory device configured to store instructions that, when executed by the at least one processor, cause the apparatus to:
determine a physical location of the apparatus; and
determine wagering game content associated with the physical location, wherein the wagering game content is for use in presenting at least one wagering game on the apparatus.

15. The apparatus of claim 14, wherein the instructions cause the apparatus to present, using the wagering game content, the wagering game on the at least one display device.

16. The apparatus of claim 14, wherein the instructions cause the apparatus to:
receive a selection of a first wagering game of the at least one wagering game;
present the first wagering game, wherein the first wagering game is sponsored by a first business entity;
receive a selection of a second wagering game of the at least one wagering game; and
presenting the second wagering game, wherein the second wagering game is sponsored by a second business entity.

17. One or more machine-readable storage media including instructions which, when executed by one or more processors, cause the one or more processors to perform operations comprising:
determining a position of a mobile device;
determining, a distance of the position of the mobile device to a physical location; and
selecting wagering game content for use in presenting at least one wagering game, wherein the selecting is based on the distance of the position of the mobile device to the physical location.

18. The one or more machine-readable storage media of claim 17, wherein the operations further comprise presenting, using the wagering game content, the at least one wagering game.

19. The one or more machine-readable storage media of claim 17, wherein the wagering game content comprises prizes awarded as a result of play of the at least one wagering game, wherein a value of the prize increases as the position of the mobile device is closer to the physical location.

20. The one or more machine-readable storage media of claim 19, wherein the physical location is associated with a business entity, and wherein a portion of the wagering game content is sponsored by the business entity.

21. The one or more machine-readable storage media of claim 20, wherein the prize comprises at least one non-monetary award selected from a group consisting of a product and a service of the business entity.

22. The one or more machine-readable storage media of claim 17, wherein the operations further comprise:
determining a winning result for the at least one wagering game by a first wagering game player;
in response to the winning result,
inviting a second wagering game player to play the at least one wagering game, wherein the first wagering game player and the second wagering game player are part of a group in a social network, and
awarding a group prize after all in the group have achieved winning results for the at least one wagering game.

23. An apparatus comprising:
means for determining, by one or more processors, a physical location of the apparatus; and
means for determining wagering game content associated with the physical location, wherein the wagering game content is for use in presenting at least one wagering game on the apparatus.

24. The apparatus of claim 23, further comprising means for presenting, using the wagering game content, the wagering game on the apparatus.

25. The apparatus of claim 23, further comprising:
means for receiving a selection of a first wagering game of the at least one wagering game;
means for presenting the first wagering game, wherein the first wagering game is sponsored by a first business entity; and
means for receiving a selection of a second wagering game of the at least one wagering game; and
means for presenting the second wagering game, wherein the second wagering game is sponsored by a second business entity.
